(19) United States
(12) Patent Application Publication
(10) Pub. No.: US 2013/0112698 A1
(43) Pub. Date: May 9, 2013

(54) CASE STRUCTURE

(71) Applicants: Zhang-Rong JIN, Taipei City (TW); Zhong-Hui Mao, Taipei City (TW); Te-Hsiung Hsieh, Taipei City (TW)

(72) Inventors: Zhang-Rong JIN, Taipei City (TW); Zhong-Hui Mao, Taipei City (TW); Te-Hsiung Hsieh, Taipei City (TW)

(21) Appl. No.: 13/569,761

(22) Filed: Aug. 8, 2012

(30) Foreign Application Priority Data
Nov. 7, 2011 (CN) 201120436134.X

(51) Int. Cl. G06F 1/16

(52) U.S. Cl. 220/694

(57) ABSTRACT

A case structure is disclosed. The case structure includes a plastic panel, a case portion, and a plurality of supporting parts. The case portion includes an assembly part. The assembly part is connected to the plastic panel for assembling. The plurality of supporting parts is connected to the assembly part. The plurality of supporting parts supports the inside of the plastic panel.

### BACKGROUND OF THE INVENTION

1. Field of the Invention

The present invention relates to a case structure; more particularly, the present invention relates to a case structure which uses a supporting part to keep the outward appearance and shape.

2. Description of the Related Art

As technology develops, many kinds of electronic devices are wildly applied to many situations. Therefore, in addition to the great performance of the electronic device, the customer also asks for beautiful outward appearance or other special design of the case of the electronic devices.

Please refer to FIG. 1, which illustrates a schematic drawing of the outward appearance of the case structure of the prior art. The case structure 90 is a desktop computer case as an example. As shown in FIG. 1, the common case structure 90 is usually formed by the combination of a case 92 and a front plastic panel 91, the case 92 and the plastic panel 91 are fastened to each other via the hooks (not shown). The case 92 and the plastic panel 91 can further include a slot, a button, a cooling hole, or special patterns for decoration. But a depression 91 a often occurs in the connecting area of the plastic panel 91 and the case 92, because of the deformation of the plastic panel 91 or being crashed by an external force, such that the outward appearance of the case structure 90 is damaged.

In order to solve the depression 91a problem of the plastic panel 91 of the prior art, a reinforcement structure is applied to the inside of the plastic panel 91 to increase the strength of the plastic panel 91. However, the cost of the plastic panel 91 will increase, and the strength for withstanding the external force is limited. On the other hand, in the process of forming the plastic panel 91 of the prior art, the shape of the plastic panel 91 can be specially designed to prevent the deformation of the plastic. But the yield rate of the producing of the plastic panel 91 will decrease, and the time and difficulty of design of the plastic panel 91 will increase, such that the cost of producing will increase.

Therefore, there is a need to provide a new case structure to solve the problem of the prior art.

### SUMMARY OF THE INVENTION

It is an object of the present invention to provide a case structure which uses a supporting part to keep the outward appearance and shape.

To achieve the abovementioned object, the case structure of the present invention comprises a plastic panel, a case portion, and a plurality of supporting parts. The case portion comprises an assembly part. The assembly part is connected to the plastic panel for assembling. The plurality of supporting parts is connected to the assembly part; wherein the plurality of supporting parts supports the inside of the plastic panel.

### BRIEF DESCRIPTION OF THE DRAWINGS

FIG. 1 illustrates a schematic drawing of the outward appearance of the case structure of the prior art.

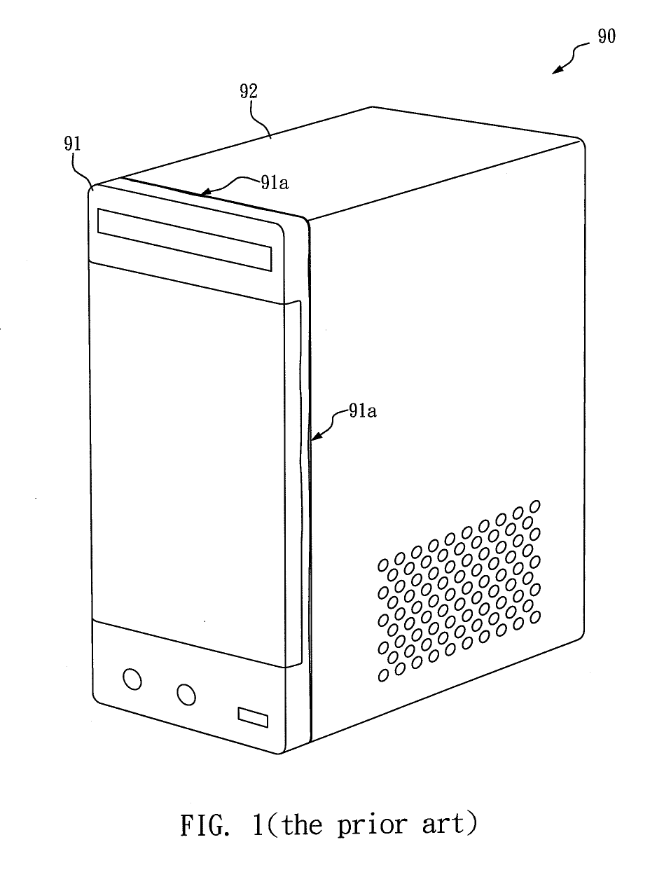

FIG. 2 illustrates a schematic drawing of the assembling of the plastic panel and the case portion of the case structure in the first embodiment of the present invention.

FIG. 3 illustrates a cross-sectional drawing of the assembling of the plastic panel and the case portion of the case structure of the present invention.

FIG. 4 illustrates a schematic drawing of the assembling of the plastic panel and the case portion of the case structure in the second embodiment of the present invention.

### DETAILED DESCRIPTION OF THE PREFERRED EMBODIMENTS

These and other objects and advantages of the present invention will become apparent from the following description of the accompanying drawings, which disclose several embodiments of the present invention. It is to be understood that the drawings are to be used for purposes of illustration only, and not as a definition of the invention.

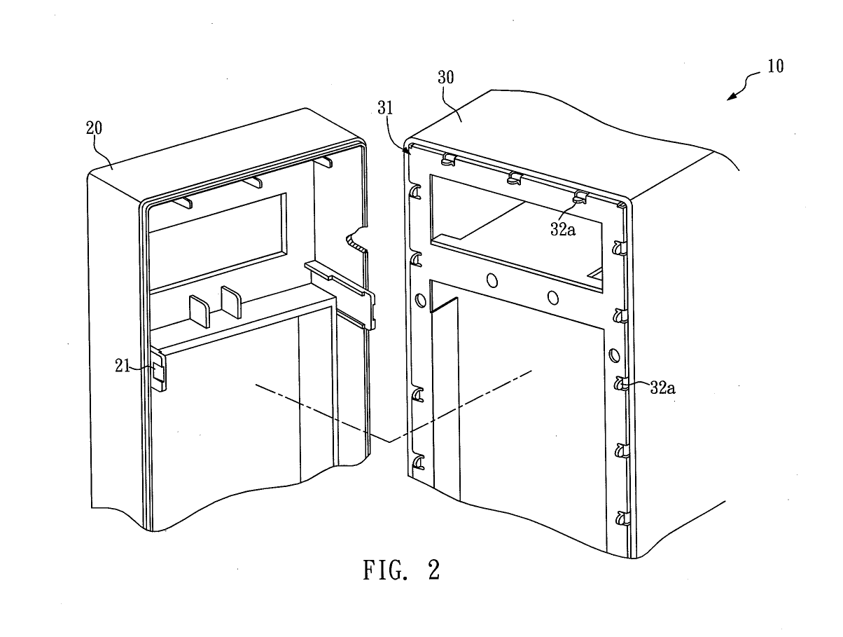

Please refer to FIG. 2, which illustrates a schematic drawing of the assembling of the plastic panel and the case portion of the case structure in the first embodiment of the present invention.

In the first embodiment of the present invention, the case structure 10 is a desktop computer case, but the present invention is not limited to that application, the case structure 10 can be applied to other electronic devices. The case structure 10 comprises a plastic panel 20 and a case portion 30, and a plurality of supporting parts, the plastic panel 20 and the case portion 30 are used for protecting the circuit board or the electronic elements inside (not shown).

The outward appearance of the plastic panel 20 can be designed to comprise a plurality of button or slots, allowing the user to operator. But it is not the focus of improvement of the present invention, so there is no need to describe here. The case portion 30 is a metal case, such as being made of iron, but the present invention is not limited to that design. The inside of the plastic panel 20 comprises a fastening element 21. The case portion 30 comprises an assembly part 31. The assembly part 31 is connected to the plastic panel 20. The fastening element 21 can be fastened to the assembly part 31, allowing the plastic panel 20 to be fastened to the case portion 30 for assembling.

When the plastic panel 20 and the case portion 30 are assembled, the plurality of supporting parts which are connected to the assembly part 31 withstand the inside of the plastic panel 20, for supporting the plastic panel 20. In the first embodiment of the present invention, the plurality of supporting parts are the plurality of bending metal elements 32a which are stretching and located on the assembly part 31. The plurality of bending metal elements 32a and the case portion 30 are integrally formed. The plurality of bending metal elements 32a can directly withstand the inside of the plastic panel 20, for preventing the edge of the plastic panel 20 to bend inward. The assembly part 31 of the present invention can comprise four sides, the plurality of bending metal elements 32a can be located on three sides of the assembly part 31, which means the plurality of bending metal elements 32a may not be located below the case portion 30, but the present invention is not limited to that design.

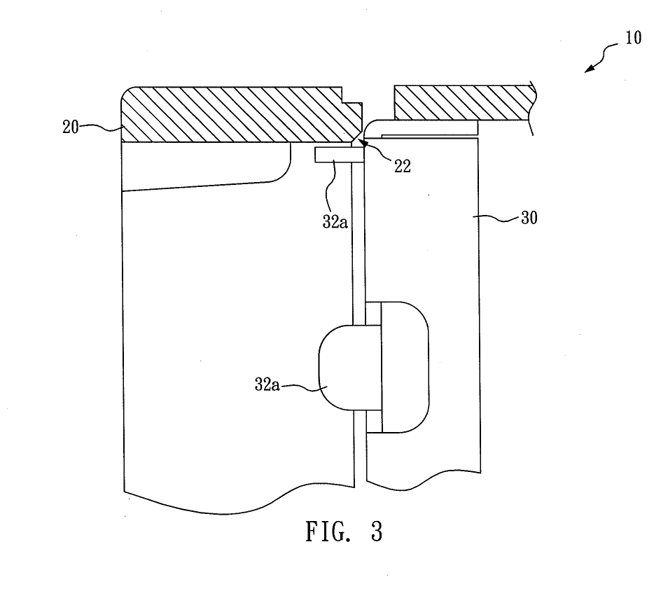

Please refer to FIG. 3, which illustrates a cross-sectional drawing of the assembling of the plastic panel and the case portion of the case structure of the present invention.

As shown in FIG. 3, when the plastic panel 20 and the case portion 30 are assembled, the plurality of bending metal elements 32a withstand the inside of the plastic panel 20, for supporting the edge area of the plastic panel 20, to prevent the edge of the plastic panel 20 to be bended due to the time or external force factors. A chamfer part 22 which towards inside can also be located on the inside of the plastic panel 20, for matching the shape of the case portion 30, to prevent the plastic panel 20 to hit the bending metal element 32a when the case portion 30 is assembled to the plastic panel 20.

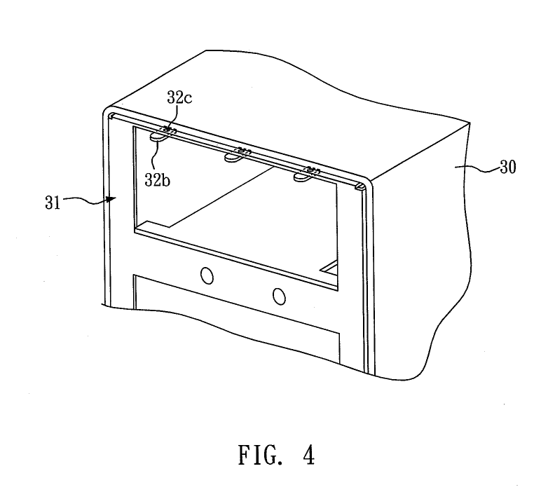

Please refer to FIG. 4, which illustrates a schematic drawing of the assembling of the plastic panel and the case portion of the case structure in the second embodiment of the present invention.

The shape of the supporting part of the assembly part 31 is not limited to the bending metal element 32a; the shape can be designed to different forms according to the structure of the case portion 30. In the second embodiment of the present invention, the plurality of supporting parts is a plurality of extension elements 32b. The plurality of extension elements 32b are protruded from the case portion 30. The plurality of extension elements 32b are combining with the plurality of rivets 32c to form the supporting part. The extension element 32b is made of metal, but the present invention is not limited to that design. One end of each of the plurality of extension elements 32b is fastened to the assembly part 31 of the case portion 30 via the rivet 32c, another end of each of the plurality of extension element 32b withstands the inside of the plastic panel 20, for supporting the edge of the plastic panel 20. In the same way, the inside of the plastic panel 20 can comprise a chamfer part 22 (as shown in FIG. 3), for preventing the plastic panel 20 to hit the bending metal element 32a.

The plurality of extension elements 32b can be located to three sides of the assembly part 31, but the present invention is not limited to that design.

Base on the abovementioned structure, the plastic panel 20 will not be bended due to time or external force factors, such that the outward appearance of the case structure 10 is kept, and the problem of the prior art is solved.

It is noted that the above-mentioned embodiments are only for illustration. It is intended that the present invention cover modifications and variations of this invention provided they fall within the scope of the to following claims and their equivalents. Therefore, it will be apparent to those skilled in the art that various modifications and variations can be made to the structure of the present invention without departing from the scope or spirit of the invention.

What is claimed is:

1. A case structure comprising:
a plastic panel;
a case portion comprising:
an assembly part connected to the plastic panel for assembling; and
a plurality of supporting parts connected to the assembly part; wherein the plurality of supporting parts support an inside of the plastic panel.

2. The case structure as claimed in claim 1, wherein the plurality of supporting parts are a plurality of bending metal elements; the plurality of bending metal elements and the case portion are integrally formed.

3. The case structure as claimed in claim 1, wherein the plurality of supporting parts is a plurality of extension elements; the plurality of extension elements is protruded from the case portion.

4. The case structure as claimed in claim 3, wherein one end of each of the plurality of extension elements is fastened to the case portion; another end of each of the plurality of extension elements supports the inside of the plastic panel.

5. The case structure as claimed in claim 1, wherein the inside of the plastic panel further comprises a chamfer part for matching a shape of the case portion.

6. The case structure as claimed in claim 1, wherein the assembly part comprises four sides, the plurality of supporting parts are located on three sides of the assembly part.

7. The case structure as claimed in claim 1, wherein the case structure is a desktop computer case.

8. The case structure as claimed in claim 1, wherein the case is a metal case.
